(19) United States
(12) Patent Application Publication
(10) Pub. No.: US 2012/0210941 A1
(43) Pub. Date: Aug. 23, 2012

(54) PET BOWL

(76) Inventor: Jeffrey Brown, San Clemente, CA (US)

(21) Appl. No.: 13/368,214

(22) Filed: Feb. 7, 2012

Related U.S. Application Data
(60) Provisional application No. 61/444,305, filed on Feb. 18, 2011.

(51) Int. Cl. A01K 5/01; A01K 29/00

(52) U.S. Cl. 119/61.52

(57) ABSTRACT

The present invention is a non-skid pet bowl designed to keep the temperature of the contents of the bowl cool. The pet bowl preferably includes a bowl, removable bottom, freezable gel insert, and non-skid portions. The bowl is configured to have air gaps to act as insulation. The bowl and removable bottom are configured to hold a freezable gel insert that can be frozen to cool the contents of the pet bowl. The non-skid portions prevent the bowl from sliding on a ground and prevent spills. The bowl is made of a heavy stainless steel to prevent the bowl from being easily tipped over by the pet.

Priority is claimed from U.S. Provisional Patent Application No. 61/444,305, filed on Feb. 18, 2011, entitled “Container”, by inventor Jeffrey Brown, the contents of which are expressly incorporated herein by this reference.

### FIELD OF THE INVENTION

The present invention relates generally to a water and food bowl for household pets. In particular, this invention is a non-skid pet bowl, which includes a freezable gel insert designed to keep the content of the bowl at cool temperatures for long periods of time.

### BACKGROUND OF THE INVENTION

Pet owners usually feed their household pets by leaving food or water inside a bowl. Conventional bowls utilized for household pets typically comprise of a circular bowl constructed out of metal, such as aluminum, or molded plastic. These bowls typically include a base integrally formed with a wall to form a concave receptacle, which is used to hold the water and/or food. These bowls are inexpensive to manufacture, easy to clean, and durable, which makes them popular with pet owners.

Despite these benefits, conventional pet bowls have several disadvantages. For example, one significant disadvantage of conventional pet bowls is that, as time passes, water that is retained within the bowl warms to the ambient temperature or even hotter if the bowl is in direct sunlight. This may cause water in the pet bowl, especially on hot days, to become undesirable to the pet, and in turn, may deter the pet from drinking the water needed to stay hydrated. This is especially troublesome because pets, such as dogs, pant to cool down, a process that is much more efficient when they have cool water to drink.

Another disadvantage is that conventional pet dishes may slide or skid as the pet is drinking, which in turn may lead to water spilling out of the bowl as the dish slides. The convention pet bowl slides because it is light weight and does not have an anti-skid surface. The light weight of the dish also leads to the pet overturning the entire bowl, which results in an undesired mess.

Although some recent improvements in pet bowls have addressed the problems of spillage by including an anti-spilling feature such as a lip guard that is circumferentially disposed within the perimeter of the bowl to prevent spilling as the pet drinks. However, quick, sliding movements of the bowl can still continue to cause water to spill. Other bowls have also incorporated non-skid technology and cooling mechanism, but no bowl available today that is non-skid, cooling, convertible, heavyweight, ant and pest resistant, and configured to be air insulated.

Therefore, what is needed is a non-skid, cooling, convertible, heavyweight, and pest resistant that is still durable and affordable.

### SUMMARY OF THE INVENTION

To minimize the limitations in the prior art, and to minimize other limitations that will become apparent upon reading and understanding the present specification, the present invention discloses a new and useful pet bowl for household pets.

One embodiment of the invention is a pet bowl comprising: a bowl and a freezable gel insert. Preferably, the bowl including one or more fasteners and a removable bottom. Preferably, the bowl is substantially hollow such that the freezable gel insert fits within the substantially hollow bowl and cools a contents of the bowl. Preferably, the removable bottom attaches to the bottom of the bowl to substantially contain the freezable gel insert. Preferably, the fasteners are configured to substantially secure the bowl to the removable bottom, such that a pet is substantially prevented from accessing the freezable gel insert. Preferably, the removable bottom has one or more non-skid portions, wherein the one or more non-skid portions are positioned on an underside of the removable bottom and substantially prevent the removable bottom from skidding. Preferably, the bottom surface of the bowl has one or more non-skid portions, such that when the removable bottom is not attached to the bowl the one or more non-skid portions on the bottom surface of the bowl substantially prevent the bowl from skidding. Preferably, when the freezable gel insert is contained within the bowl by the removable bottom, the bowl includes one or more insulating air pockets. Preferably one of the one or more insulating air pockets is located between an outer side of the freezable gel insert and an outer side of the bowl. Preferably, the removable bottom includes one or more raised portions—preferably ringed shaped—wherein the one or more ring shaped raised portions are on an upper surface of the removable bottom. Preferably, when the freezable gel insert is contained within the bowl by the removable bottom, the one or more ring shaped raised portions create one of the one or more insulating air pockets between the freezable gel insert and an upper surface of the removable bottom. Preferably, the removable bottom includes a raised lip. Preferably, when the removable bottom is attached to the bowl, the raised lip of the removable bottom is configured to capture a liquid that is spilled from a concave receptacle of the bowl. Preferably, when the removable bottom is attached to the bowl, the raised lip and a rim of the bowl combine to form a trough, such that when the trough is filled with liquid, the trough forms a barrier that substantially prevents pests from accessing the concave receptacle of the bowl. Preferably, the freezable gel insert is a high density polyethylene container that contains a non-toxic freezable gel. Preferably, the freezable gel insert includes one or more insulating air gaps on a surface of the high density polyethylene container. Preferably, the insulating air gaps on the freezable gel insert are configured to accommodate an expansion of the non-toxic freezable gel such that the high density polyethylene container is substantially prevented from deforming as a result of repeated use. Preferably, the bowl and the removable bottom are substantially stainless steel.

Another embodiment of the present invention is a pet bowl, comprising: a bowl and a freezable gel insert. The bowl includes a removable bottom, and the bowl is substantially hollow. The freezable gel insert fits within the substantially hollow bowl, such that when the substantially hollow bowl contains the freezable gel insert, a pet cannot access the freezable gel insert. Preferably, the pet bowl further comprises one or more non-skid portions; wherein the one or more non-skid portions are positioned at an undersurface of the removable bottom to prevent a sliding of the removable bottom. Preferably, the bowl includes one or more insulating air pockets. The one or more insulating air pockets should be located between the freezable gel insert and the bowl, and the one or more insulating air pockets should provide a temperature insulation of the bowl. Preferably, the removable bottom includes a one or more raised portions. The one or more raised portions is typically positioned at an above surface of the removable bottom and is substantially opposite of the one or more non-skid portions, such that the one or more insulating air pockets is formed between the one or more raised portions and the one or more non-skid portions. The one or more non-skid portions are typically positioned at a bottom surface of the bowl to prevent the sliding of the bowl. Generally, the freezable gel insert is a high density polyethylene container, and the high density polyethylene container should include a non-toxic freezable gel. Typically, the freezable gel insert includes one or more insulating air gaps; wherein the one or more insulating air gaps are configured to accommodate an expansion of the frozen freezable gel insert. The removable bottom should include a raised lip; wherein the raised lip of the removable bottom is configured to capture a liquid that is dripped from a concave receptacle of the bowl. Preferably, the raised lip and a rim of the bowl when combined is configured to form a trough, such that when the trough is filled with the liquid, the trough forms a moat bather to prevent one or more insects from accessing the concave receptacle of the bowl. The pet bowl should further comprise of one or more fasteners; wherein the one or more fasteners is configured to secure the bowl to the removable bottom.

Another embodiment of the present invention is a pet bowl, comprising: a bowl and a freezable gel insert. The bowl is substantially hollow, and the bowl includes a removable bottom. The freezable gel insert fits within the substantially hollow bowl, such that when the substantially hollow bowl contains the freezable gel insert, a pet cannot access the freezable gel insert. The removable bottom includes one or more fasteners, and the one or more fasteners is configured to secure the bowl to the removable bottom. Preferably, the pet bowl further comprises one or more non-skid portions; wherein the one or more non-skid portions is positioned at an undersurface of the removable bottom to prevent a sliding of the removable bottom. Preferably, the bowl includes one or more insulating air pockets. The one or more insulating air pockets are typically located between the freezable gel insert and the bowl, and the one or more insulating air pockets preferably provide a temperature insulation of the bowl. Preferably, the removable bottom includes a one or more raised portions. The one or more raised portions is typically positioned at an above surface of the removable bottom and is typically substantially opposite of the one or more non-skid portions, such that the one or more insulating air pockets is formed between the one or more raised portions and the one or more non-skid portions. The one or more non-skid portions are generally positioned at a bottom surface of the bowl to prevent the sliding of the bowl. The freezable gel insert should be a high density polyethylene container; wherein the high density polyethylene container includes a non-toxic freezable gel. The freezable gel insert typically includes one or more insulating air gaps; wherein the one or more insulating air gaps are configured to accommodate an expansion of the frozen freezable gel insert. The removable bottom should include a raised lip; wherein the raised lip of the removable bottom is configured to capture a liquid that is dripped from a concave receptacle of the bowl. The bowl is preferably constructed out of stainless steel.

Another embodiment of the present invention is a pet bowl, comprising: a bowl; a freezable gel insert; one or more non-skid portions; one or more insulating air pockets; and one or more fasteners. The bowl includes a removable bottom, and the bowl is substantially hollow. The freezable gel insert fits within the substantially hollow bowl, such that when the substantially hollow bowl contains the freezable gel insert, a pet cannot access the freezable gel insert. The one or more non-skid portions are positioned at an undersurface of the removable bottom to prevent a sliding of the removable bottom. The one or more non-skid portions are positioned at a bottom surface of the bowl to prevent the sliding of the bowl. The one or more insulating air pockets are located between the freezable gel insert and the bowl. The one or more insulating air pockets provide a temperature insulation of the bowl. The removable bottom includes a one or more raised portions and a raised lip; wherein the one or more raised portions is positioned at an above surface of the removable bottom and is substantially opposite of the one or more non-skid portions, such that the one or more insulating air pockets is formed between the one or more raised portions and the one or more non-skid portions. The raised lip and a rim of the bowl when combined is configured to form a trough, such that when the trough is filled with the liquid, the trough forms a moat bather to prevent one or more insects from accessing the concave receptacle of the bowl. The freezable gel insert is a high density polyethylene container; wherein the high density polyethylene container includes a non-toxic freezable gel. The freezable gel insert includes one or more insulating air gaps; wherein the one or more insulating air gaps are configured to accommodate an expansion of a frozen freezable gel insert. The one or more fasteners is configured to secure the bowl to the removable bottom.

It is an object of the present invention to provide a pet bowl that is kept chilled by a freezable gel insert, which effectively keeps the pet bowl below ambient temperature for at least 8 hours.

It is an object of the present invention to provide a pet bowl that includes a non-skid material to prevent the pet bowl from sliding on a grounded surface.

It is an object of the present invention to provide a pet bowl that is constructed out of heavy-gauge, stainless steel for ease of use, and durability. The stainless steel pet bowl is preferably dishwasher safe.

It is an object of the present invention to provide a pet bowl that contains one or more insulator air pockets and/or gaps to add thermal insulation and minimize caloric transfer.

It is an object of the present invention to provide a pet bowl that includes one of several mechanisms to fasten, friction, and/or lock the freezable gel insert within the pet bowl so that the pet cannot gain access to the insert.

It is an object of the present invention to provide a freezable gel insert that is durable and specially designed such that is able to be frozen numerous times without becoming deformed during the expansion and contraction caused by the freezing and thawing.

It is an object of the present invention to provide a pet bowl with a trough, such that when the trough is filled with water or other liquid, the water-filled trough functions as a liquid barrier to prevent insects such as ants from accessing the food or water contained within the pet bowl.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the pet bowl.

FIG. 2 is an illustration of a exploded view of one embodiment of the pet bowl.

FIG. 3 is an illustration of a top view of one embodiment of the bowl of the pet bowl and shows the bowl without the removable bottom and freezable gel insert.

FIG. 4 is an illustration of a bottom view of one embodiment of the bowl of the pet bowl and shows the bowl without the removable bottom and freezable gel insert.

FIG. 5 is an illustration of a cross-sectional side view of one embodiment of the bowl of the pet bowl and shows the bowl without the removable bottom and freezable gel insert.

FIG. 6 is an illustration of a top view of one embodiment of the freezable gel insert of the pet bowl.

FIG. 7 is an illustration of a bottom view of one embodiment of the freezable gel insert of the pet bowl.

FIG. 8 is an illustration of a cross-sectional side view of one embodiment of the freezable gel insert of the pet bowl.

FIG. 9 is an illustration of a top view of one embodiment of the removable bottom of the pet bowl.

FIG. 10 is an illustration of a bottom view of one embodiment of the removable bottom of the pet bowl.

FIG. 11 is an illustration of a cross-sectional side view of one embodiment of the removable bottom of the pet bowl.

FIG. 12 is an illustration of a cross-sectional side view of one embodiment of the pet bowl and shows the inner components of the pet bowl.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the term “fastener” refers to any device that attaches, secures, or locks the bowl to the removable bottom, including without limitation, twist-and-lock fasteners, alignment notches and tabs, snapping or friction mechanisms with dimples/protrusions, metal/plastic clips, clasps, straps, hook and loop fasteners, screws, bolts, adhesives, wires, nylons, snap hooks, loops, solder, flux, nuts, washers, rivets, turnbuckles, and the like.

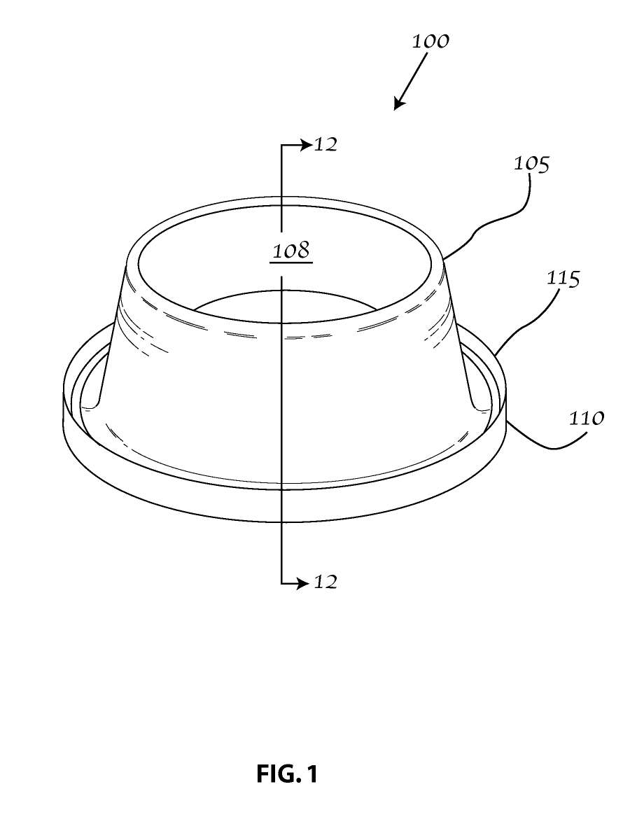

FIG. 1 is an illustration of a perspective view of one embodiment of the pet bowl. As shown in FIG. 1, the pet bowl 100 preferably includes a bowl 105 and a removable bottom 110. The bowl 105 preferably is a circular bowl with a concave receptacle 108, which is used to hold water and/or food for a household pet. The removable bottom 110 is preferably a base that can be removably attached to the bowl 105 and preferably includes a raised lip 115. The raised lip 115 is typically designed to capture any liquids that may drip outside the concave area of the bowl 105, and may be used, in conjunction with the bowl 105, as a trough, such that when the trough is filled with liquid or water, a liquid barrier is formed that prevents insects from accessing any food located within the concave receptacle 108. Both the bowl 105 and removable bottom 110 are preferably constructed out of high strength materials such as stainless steel, some other metal, or high impact plastic, but any natural or manmade material may be used without deviating from the scope of the invention.

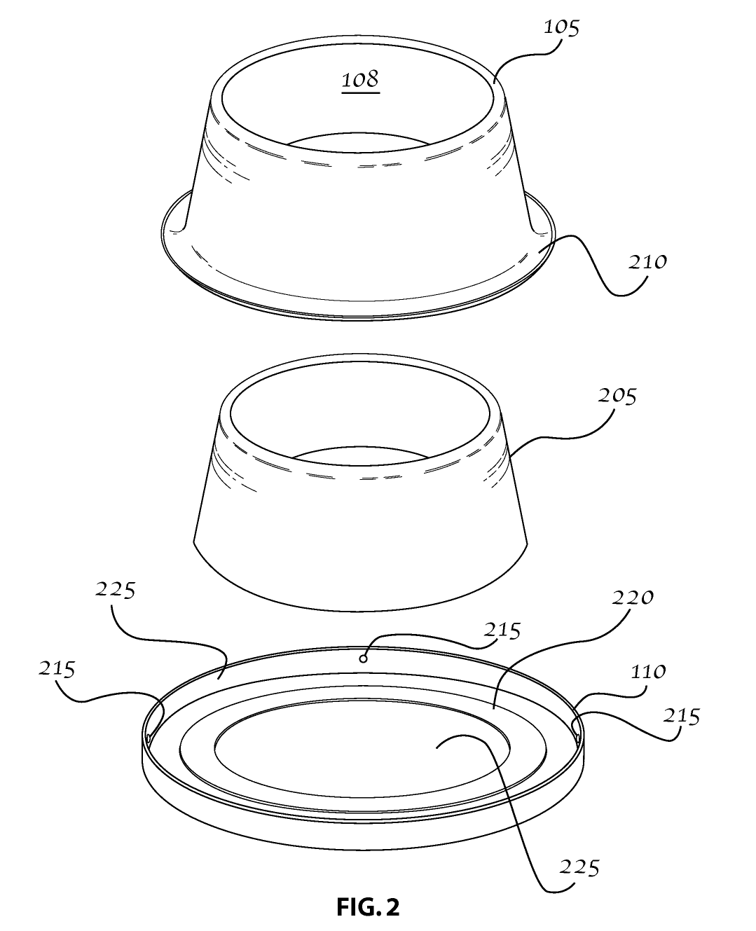

FIG. 2 is an illustration of an exploded view of one embodiment of the pet bowl. As shown in FIG. 2, the pet bowl 100 preferably includes: a bowl 105; removable bottom 110; and freezable gel insert 205. The freezable gel insert 205 is preferably a high density polyethylene container designed to chill the bowl 105 for a long period of time, and is usually filled with a freezable gel liquid or composite. However, the freezable gel insert 205 may be made out of any manmade or non-made materials without deviating from the scope of the invention, so long as it can provide the function of cooling the bowl.

As shown in FIG. 2, the bowl 105 is preferably able to fasten or attach onto the removable bottom 110 by snapping or otherwise connecting with the rim 210 of the bowl 105 against the dimples 215, which are typically located within the inner surface of the raised lip 215. Although FIG. 2 shows the fastener or connection mechanism as a friction dimple mechanism, any type of fastener may be used, including latch, slot and twist, threads, or other type of locking mechanism may be used without deviating from the scope of the invention. For example, another way of fastening, connecting, or attaching the removable bottom 110 onto the bowl 105 is by locking the rim 210 of the bowl 105 with alignment notches and tab portions. Specifically, the rim 210 of the bowl 105 may have one or more alignment notches or cut-outs, which are configured to align with tab portions, dimples, or protrusions located within the inner surface of the raised lip 115. After the tab portions engage with the alignment notches, the bowl preferably locks onto the removable bottom 100 by twisting the tabs over the main part of the rim.

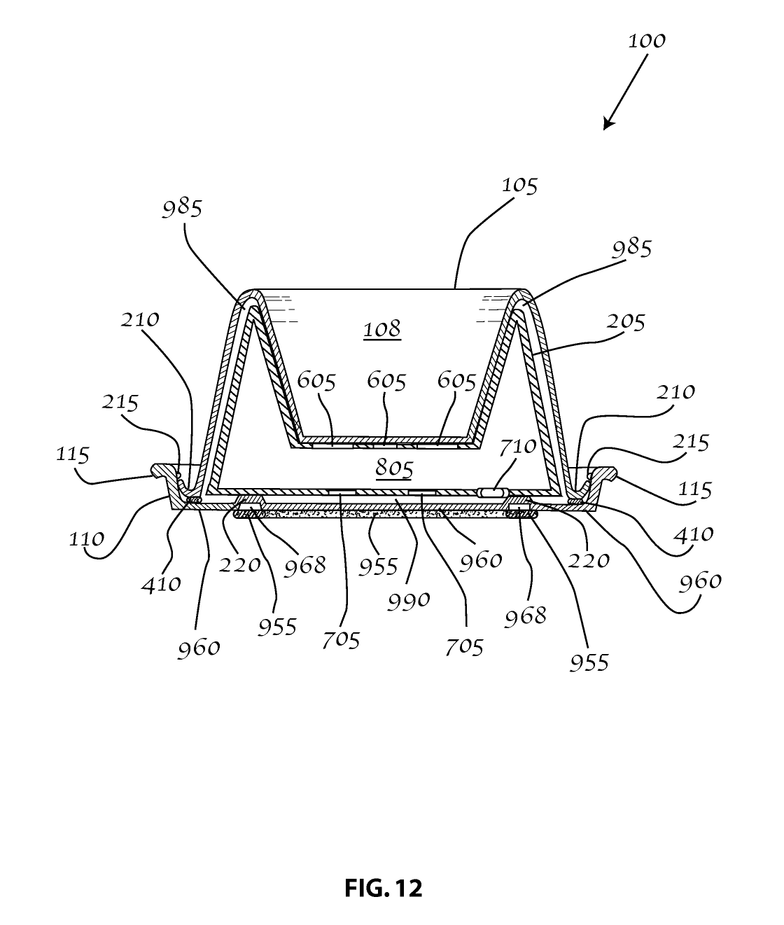

FIG. 2 also shows a ring shaped raised portion 220 located on the upper surface 225 of the removable bottom 110, which raises the freezable gel insert 205 at a slightly higher position with respect to the upper surface 225 of the removable bottom 110. By placing the freezable gel insert 205 on top of the ring shaped raised portion 220, an insulating air pocket 990 (shown in FIG. 12) is formed between the bottom of freezable gel insert 205 and upper surface 225. The insulating air pocket 990 preferably functions as a thermal insulator that slows the rise in temperature of the freezable gel insert 205. Although the ring shaped raised portion is shown as ring shaped, it should be understood that the raised portion may be any shape and may be several raised portions so long as the gel insert 205 is substantially prevented from contacting upper surface 225.

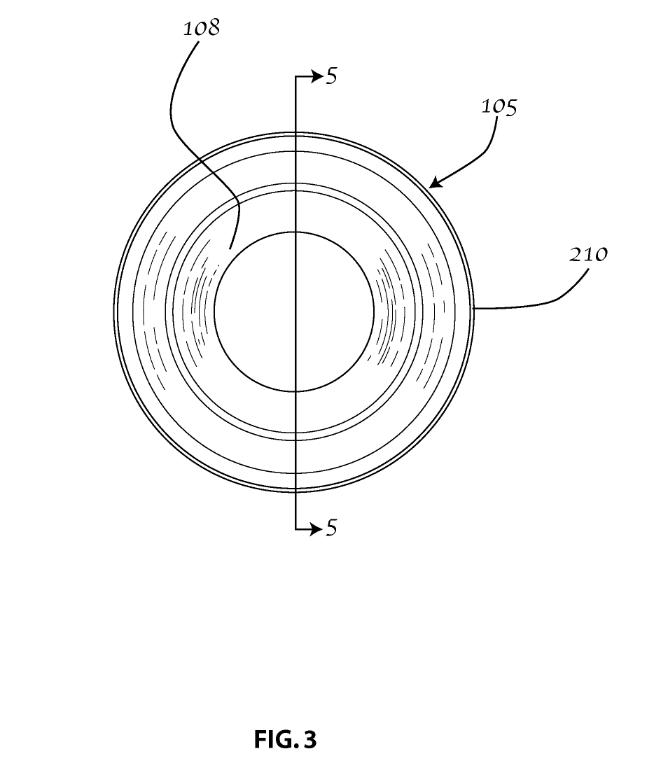

FIG. 3 is an illustration of a top view of one embodiment of the bowl of the pet bowl and shows the bowl without the removable bottom and freezable gel insert. As shown in FIG. 3, the bowl 105 preferably includes a concave receptacle 108 and rim 210. The rim 210, when used in conjunction with the raised lip 115 of the removable bottom 110, functions as a trough. The rim 210 also, as discussed above, functions as a fastening device, in which the rim 210 is snapped against the dimples 215 located on the interior side of the raised lip 115.

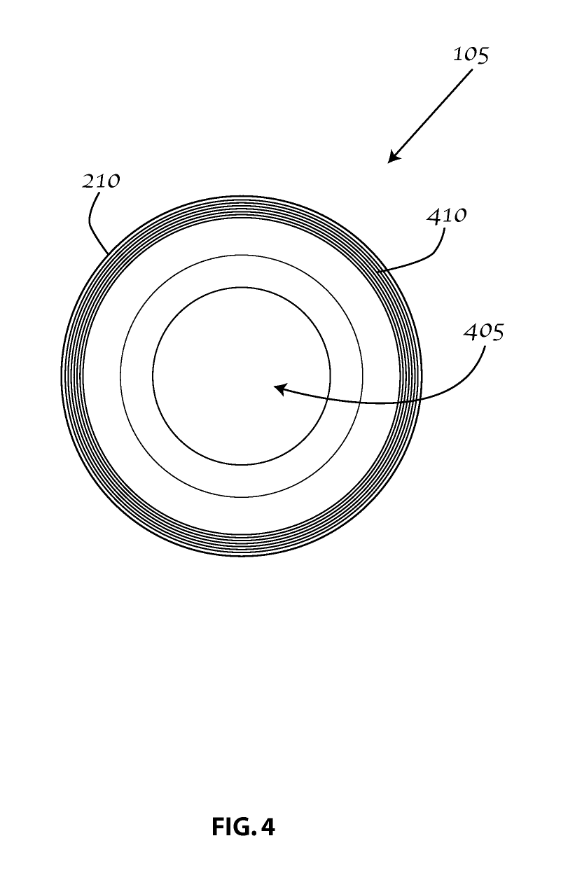

FIG. 4 is an illustration of a bottom view of one embodiment of the bowl of the pet bowl and shows the bowl without the removable bottom and freezable gel insert. As shown in FIG. 4, the bowl 105 preferably includes a cavity 405 and rim 210. The cavity 405 is typically a hollow area configured to fit the freezable gel insert 205. The cavity also preferably includes insulating air pocket 985 (shown in FIG. 12), which is formed when the freezable gel insert 205 is positioned inside the bowl 105. The insulating air pocket 985 insulates freezable gel insert 205. FIG. 4 shows that non-skid ring or portion 410 is generally located at the underside of the rim 210, such that, when the removable bottom 110 and/or freezable gel insert 205 are removed, the non-skid ring 410 functions to limit or prevent the bowl 105 from being moved and displaced when placed on a flat surface. The non-skid ring 410 is preferably made of rubber, but any type of high friction, non-skid material may be used without deviating from the scope of the invention. Non-skid ring 410 preferably acts to further insulate the gel insert 205 when the bowl 105 is combined with the removable bottom.

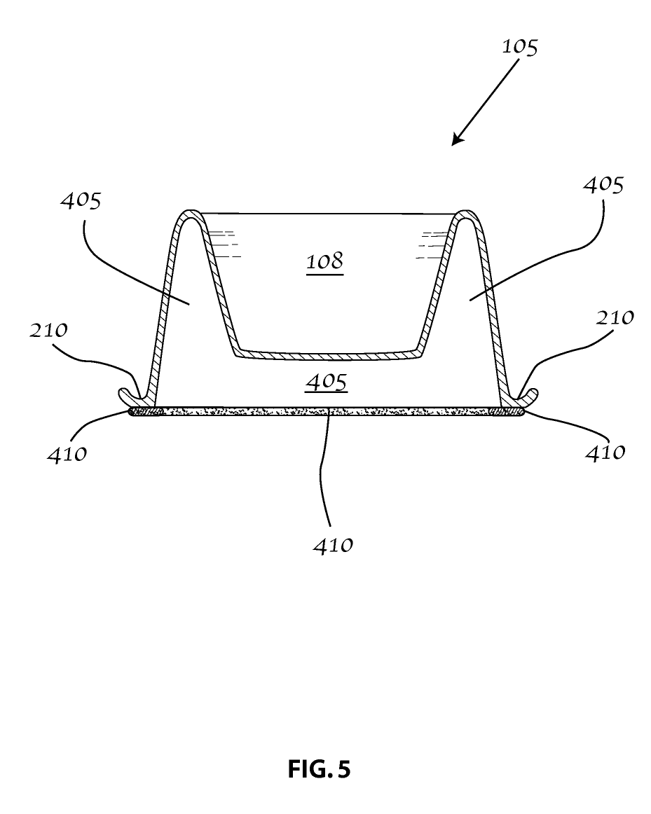

FIG. 5 is an illustration of a cross-sectional side view of one embodiment of the bowl of the pet bowl and shows the bowl without the removable bottom and freezable gel insert. As shown in FIG. 5, the bowl 105 preferably includes: a concave receptacle 108; rim 210; cavity 405; and non-skid portions 410. FIG. 5 also shows how rim 210 of bowl 105, when filled with liquid can act as moat, trough or other barrier against ants and other crawling insects.

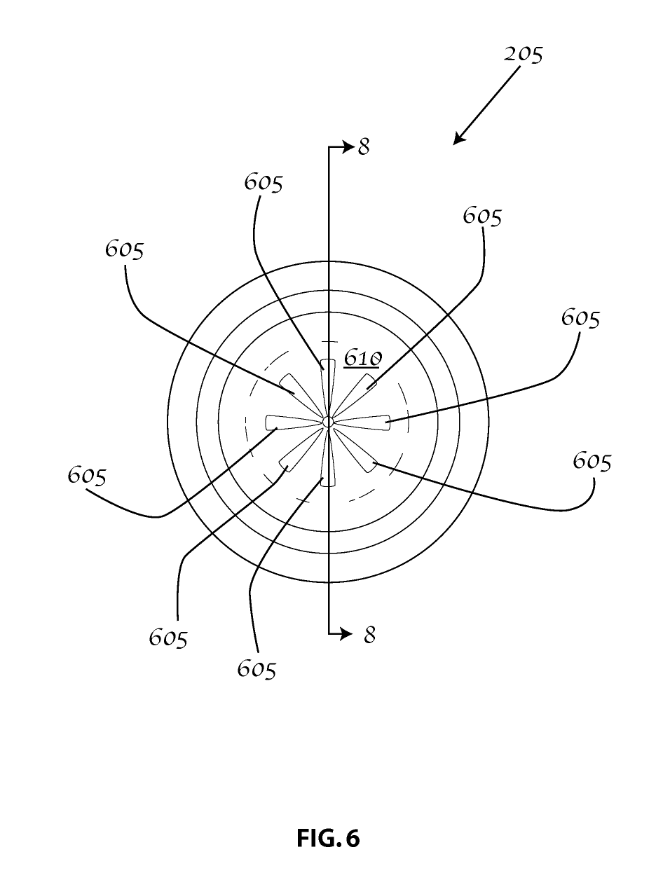

FIG. 6 is an illustration of a top view of one embodiment of the freezable gel insert of the pet bowl. As shown in FIG. 6, the freezable gel insert 205 preferably includes: insulating air gaps 605 and a concave surface 610. The insulating air gaps 605 are preferably located on the concave surface 610 of the freezable gel insert 205 and are typically rigid, depressed areas that also minimize deformation of the freezable gel insert 205 as it freezes and thaws. In particular, when the freezable gel insert 205 is frozen, the depressed areas or indentations of the insulating air gaps 605 limits damage and deformation to the shell of the insert due to the expansion and contraction of the frozen liquid. The insulating air gaps 605 also provide more rigidity to the surface of the freezable gel insert 205 to strengthen the insert 205. Without the insulating air gaps 605, bulges might form on the surface of the freezable gel insert 205 as the pet owner repeatedly freezes the insert 205. Although the concave surface 610 may have any concave shape, it is preferably shaped similar or even identically to the concave receptacle 108, such that the freezable gel insert 205 fits within the cavity 405 located at the underside of the bowl 105. Although the concave surface 610 is shaped similar to the concave receptacle 108, an insulating air pocket 985 is typically present in-between the sides bowl 105 and sides freezable gel insert 205 to help insulate and maintain the cool temperature of the insert 205.

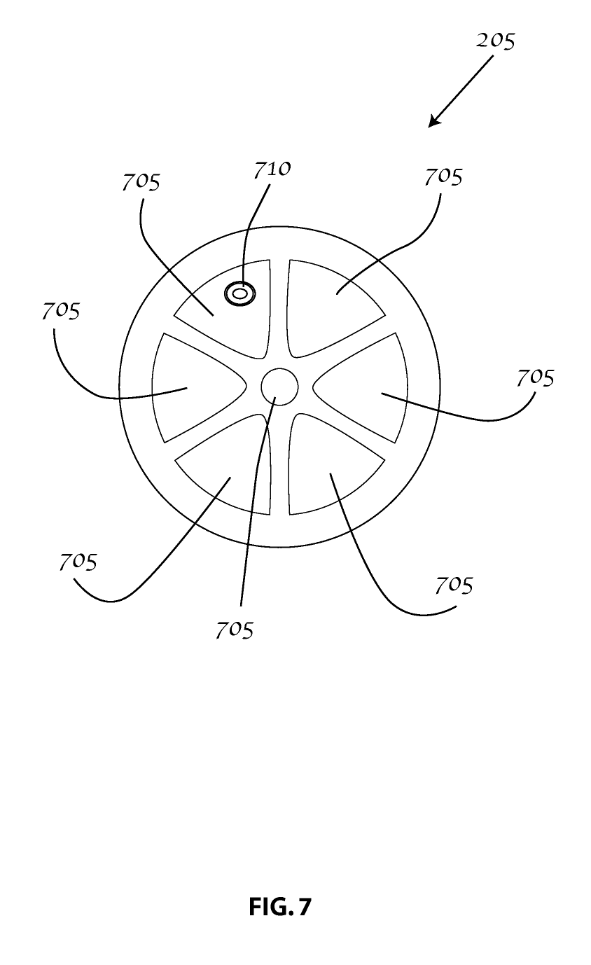

FIG. 7 is an illustration of a bottom view of one embodiment of the freezable gel insert of the pet bowl. As shown in FIG. 7, the freezable gel insert 205 includes insulating air gaps 705 and an access point plug 710. The insulating air gaps 705, as discussed above, are depressed areas on the freezable gel insert that minimize the expansion of the frozen liquid once the freezable gel insert 205 is frozen. The insulating air gaps 705 also typically provide more stiffness, rigidity, and support to the surface of the freezable gel insert 205. The access point plug 710 is preferably a plug or access mechanism, which provides access to fill the freezable gel insert 205 with freezable gel or other type of freezable liquid.

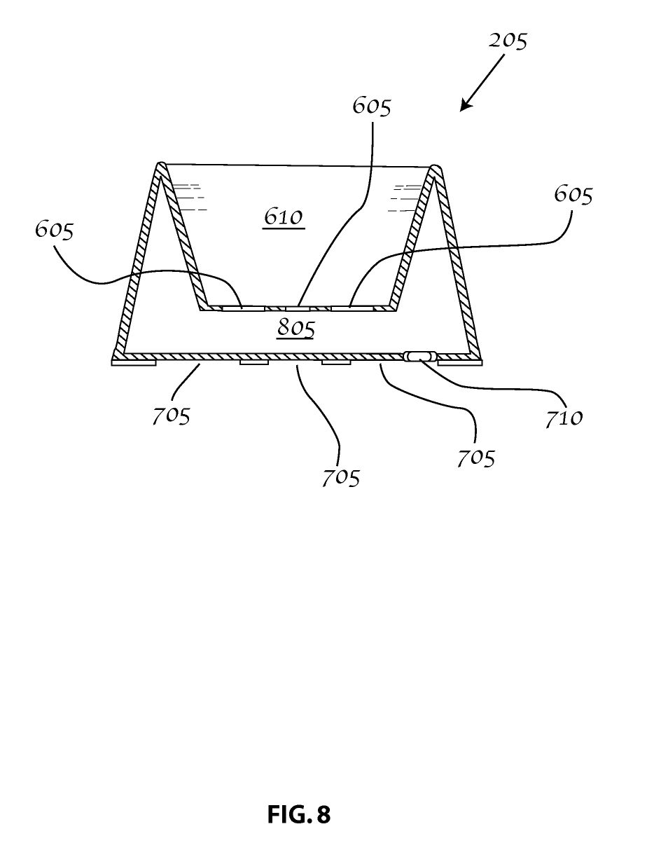

FIG. 8 is an illustration of a cross-sectional side view of one embodiment of the freezable gel insert of the pet bowl. As shown in FIG. 8, the freezable gel insert 205 preferably includes: insulating air gaps 605, 705; access point plug 710; concave surface 610; and gel compartment 805. The compartment 805 is preferably the area in which the freezable gel or liquid is held.

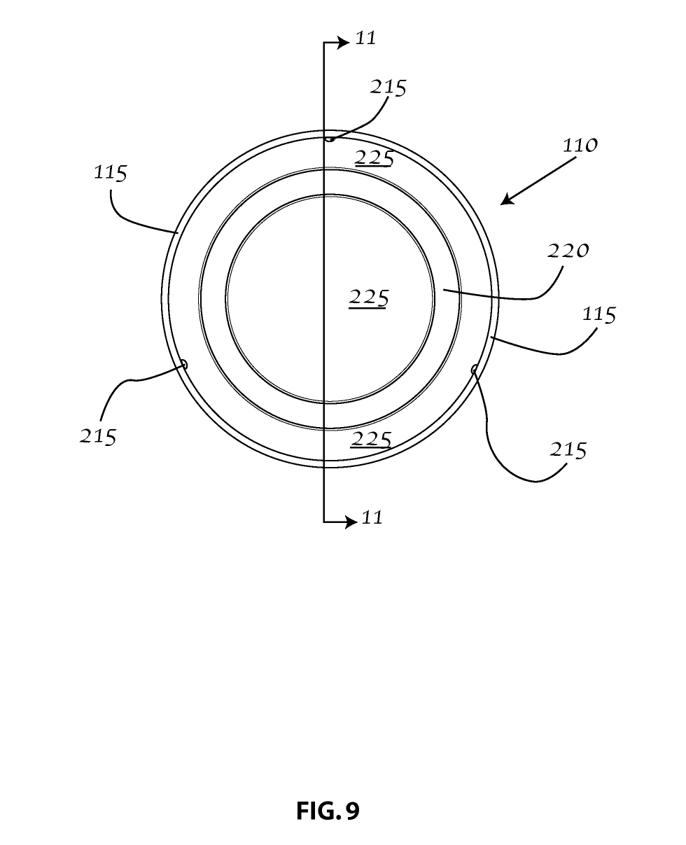

FIG. 9 is an illustration of a top view of one embodiment of the removable bottom of the pet bowl. As shown in FIG. 9, the removable bottom 110 preferably includes: a raised lip 115; dimples 215; ring shaped raised portion 220; and upper surface 225. As discussed above, the raised lip 115, when used in conjunction with the rim 210 and filed with water, preferably creates a trough, moat, or liquid barrier against ants and other pests. The dimples 215, when used in conjunction with the rim 210, allows the bowl 105 and bottom 110 to snap together to hold together the invention and prevent the pet from accessing the gel insert. Further, the ring shaped raise portion 220, when used in conjunction with the freezable gel insert 205, create an insulating air pocket 990 (shown in FIG. 12) to assist in keeping the temperature of the pet bowl 100 cool.

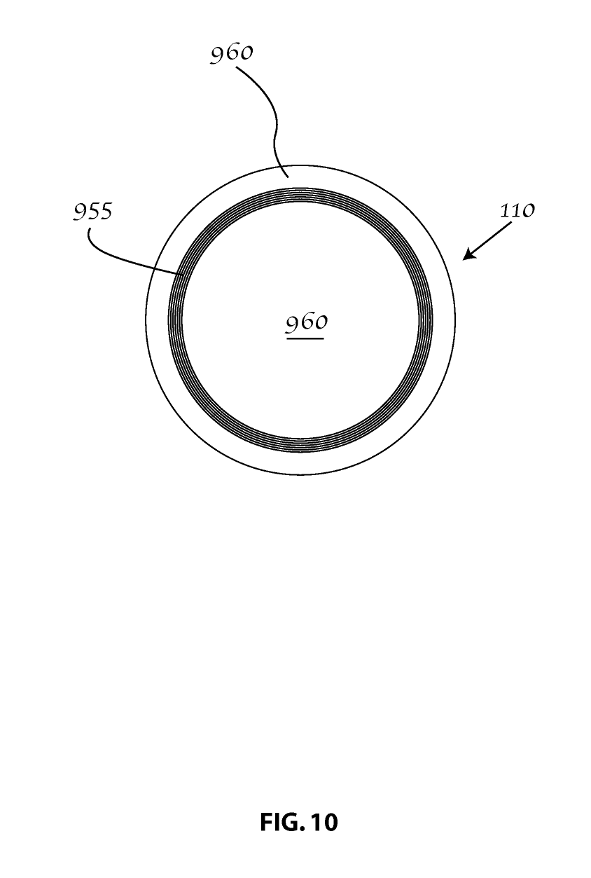

FIG. 10 is an illustration of a bottom view of one embodiment of the removable bottom of the pet bowl. As shown in FIG. 10, the removable bottom 110 preferably includes a non-skid portion 955 and a bottom surface 960. The non-skid portion 955, as discussed above, functions as non-skid material to help prevent the removable bottom 110 from being moved or displaced on a ground surface. The non-skid portion 955 is preferably made of rubber, but any type of non-skid material may be used without deviating from the scope of the invention. The bottom surface 960 is the underside of the removable bottom 110.

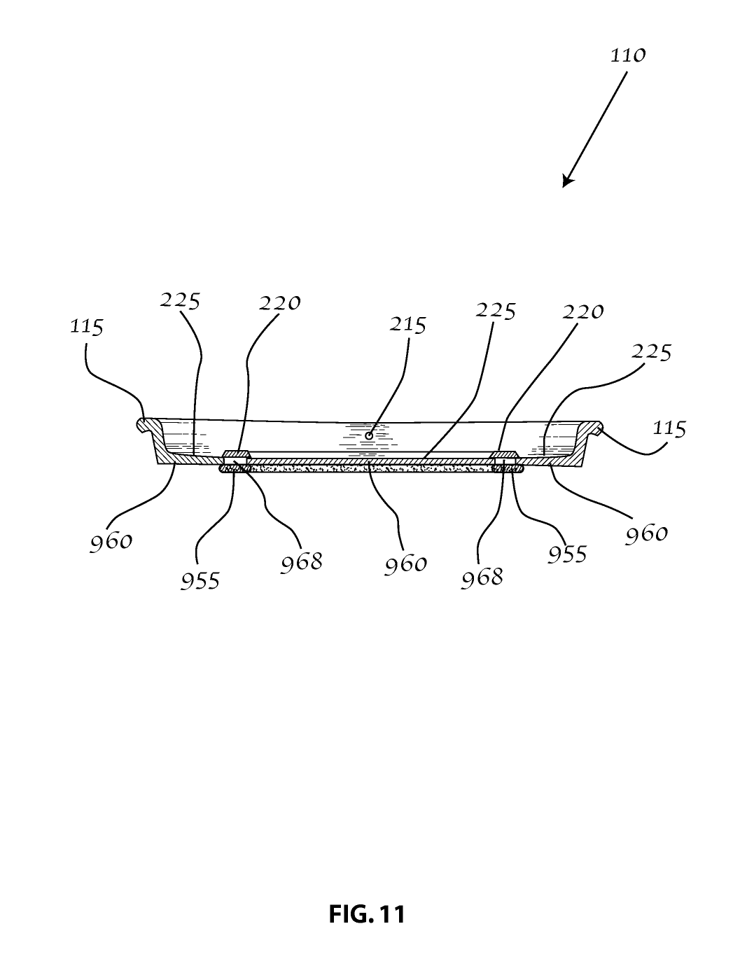

FIG. 11 is an illustration of a cross-sectional side view of one embodiment of the removable bottom of the pet bowl. As shown in FIG. 11, the removable bottom 110 preferably includes: a raised lip 115; dimple 215; ring shaped raised portion 220; upper surface 225; non-skid portion 955; bottom surface 960; and insulating air pocket 968. As discussed above, the insulating air pocket 968 helps insulate and maintain the cool temperature of the pet bowl 100.

FIG. 12 is an illustration of a cross-sectional side view of one embodiment of the pet bowl and shows the inner components of the pet bowl. As shown in FIG. 12, the pet bowl 100 preferably includes: a bowl 105; concave receptacle 108; removable bottom 110; raised lip 115; freezable gel insert 205; rim 210; dimples 215; ring shaped raised portion 220; non-skid portions 410, 955; insulating air gaps 605, 705, 968, 985, 990; access point plug 710; gel compartment 805; and bottom surface 960. Preferably, the removable bottom 110 attaches to the bowl 105, such that the freezable insert 205 is positioned within the cavity 405 within the bowl 105. Preferably, when the freezable gel insert 205 and removable bottom 110 are combined, there is no interior gap, which means that the cool gel quickly and consistently cools the water or food placed in concave receptacle 108. But, insulating air gap 990 is formed to limit cooling the outside of the bowl. This helps extend the time that the gel will cool the contents of the concave receptacle 108. FIG. 12 also shows how the lip 115 and rim 215, when filled with liquid, can act as moat, trough or other barrier against ants and other crawling insects. This trough will also catch spilled or sloshed liquid. Although FIG. 12 shows that the bowl and its three components have a specific shape, it should be understood that the bowl and its parts may have any shape so long as the gel insert efficiently cools the contents of the bowl. FIG. 12 also shows how the air gap 985, which is between an outer side of the bowl 105 and an outer side of gel insert 205, prevents the gel insert 205 from cooling an outer side of bowl 105.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A pet bowl, comprising:
a bowl; and
a freezable gel insert;
wherein said bowl includes a removable bottom;
wherein said bowl is substantially hollow such that said freezable gel insert fits within said substantially hollow bowl and cools a contents of said bowl;
wherein said removable bottom attaches to the bottom of said bowl to substantially contain said freezable gel insert.

2. The pet bowl according to claim 1, wherein said removable bottom has one or more non-skid portions;
wherein said one or more non-skid portions are positioned on an underside of said removable bottom;
wherein said one or more non-skid portions on said under side of said removable bottom substantially prevent said removable bottom from skidding.

3. The pet bowl according to claim 2, wherein when said freezable gel insert is contained within said bowl by said removable bottom, said bowl includes one or more insulating air pockets;
wherein one of said one or more insulating air pockets is located between an outer side of said freezable gel insert and an outer side of said bowl.

4. The pet bowl according to claim 3, wherein said removable bottom includes one or more raised portions;
wherein said one or more raised portions are on an upper surface of said removable bottom;
wherein when said freezable gel insert is contained within said bowl by said removable bottom said one or more raised portions create one of said one or more insulating air pockets between said freezable gel insert and an upper surface of said removable bottom.

5. The pet bowl according to claim 4, wherein said one or more raised portions is a ring shaped raised portion.

6. The pet bowl according to claim 4, wherein a bottom surface of said bowl has one or more non-skid portions, such that when said removable bottom is not attached to said bowl said one or more non-skid portions on said bottom surface of said bowl substantially prevent said bowl from skidding.

7. The pet bowl according to claim 6, wherein said freezable gel insert is a high density polyethylene container that contains a non-toxic freezable gel.

8. The pet bowl according to claim 7, wherein said freezable gel insert includes one or more insulating air gaps on a surface of said high density polyethylene container;
wherein said one or more insulating air gaps on said freezable gel insert are configured to accommodate an expansion of said non-toxic freezable gel such that said high density polyethylene container is substantially prevented from deforming as a result of repeated use.

9. The pet bowl according to claim 6, wherein said removable bottom includes a raised lip;
wherein when said removable bottom is attached to said bowl said raised lip of said removable bottom is configured to capture liquid that is spilled from a concave receptacle of said bowl.

10. The pet bowl according to claim 9, wherein when said removable bottom is attached to said bowl said raised lip and a rim of said bowl combine to form a trough, such that when said trough is filled with liquid, said trough forms a barrier that substantially prevents pests from accessing said concave receptacle of said bowl.

11. The pet bowl according to claim 9, further comprising:
one or more fasteners;
wherein said one or more fasteners are configured to substantially secure said bowl to said removable bottom, such that a pet is substantially prevented from accessing said freezable gel insert.

12. A pet bowl, comprising:
a bowl; and
a freezable gel insert;
one or more fasteners;
wherein said bowl includes a removable bottom;
wherein said bowl is substantially hollow such that said freezable gel insert fits within said substantially hollow bowl and cools a contents of said bowl;
wherein said removable bottom attaches to the bottom of said bowl to substantially contain said freezable gel insert;
wherein said one or more fasteners are configured to substantially secure said bowl to said removable bottom, such that a pet is substantially prevented from accessing said freezable gel insert.

13. The pet bowl according to claim 12, wherein said removable bottom has one or more non-skid portions;
wherein said one or more non-skid portions are positioned on an underside of said removable bottom;
wherein said one or more non-skid portions on said under side of said removable bottom substantially prevent said removable bottom from skidding;
wherein a bottom surface of said bowl has one or more non-skid portions, such that when said removable bottom is not attached to said bowl said one or more non-skid portions on said bottom surface of said bowl substantially prevent said bowl from skidding.

14. The pet bowl according to claim 13, wherein when said freezable gel insert is contained within said bowl by said removable bottom, said bowl includes one or more insulating air pockets;
wherein one of said one or more insulating air pockets is located between an outer side of said freezable gel insert and an outer side of said bowl;
wherein said removable bottom includes one or more raised portions;
wherein said one or more raised portions are on an upper surface of said removable bottom;
wherein when said freezable gel insert is contained within said bowl by said removable bottom said one or more raised portions create one of said one or more insulating air pockets between said freezable gel insert and an upper surface of said removable bottom.

15. The pet bowl according to claim 14, wherein said one or more raised portions is a ring shaped raised portion.

16. The pet bowl according to claim 15, wherein said removable bottom includes
a raised lip;
wherein when said removable bottom is attached to said bowl said raised lip of said removable bottom is configured to capture a liquid that is spilled from a concave receptacle of said bowl.

17. The pet bowl according to claim 16, wherein when said removable bottom is attached to said bowl said raised lip and a rim of said bowl combine to form a trough, such that when said trough is filled with liquid, said trough forms a barrier that substantially prevents pests from accessing said concave receptacle of said bowl.

18. The pet bowl according to claim 17, wherein said freezable gel insert is a high density polyethylene container that contains a non-toxic freezable gel.

19. The pet bowl according to claim 18, wherein said freezable gel insert includes one or more insulating air gaps on a surface of said high density polyethylene container;
wherein said one or more insulating air gaps on said freezable gel insert are configured to accommodate an expansion of said non-toxic freezable gel such that said high density polyethylene container is substantially prevented from deforming as a result of repeated use.

20. A pet bowl, comprising:
a bowl; and
a freezable gel insert;
one or more fasteners;
wherein said bowl includes a removable bottom;
wherein said bowl is substantially hollow such that said freezable gel insert fits within said substantially hollow bowl and cools a contents of said bowl;
wherein said removable bottom attaches to the bottom of said bowl to substantially contain said freezable gel insert;
wherein said one or more fasteners are configured to substantially secure said bowl to said removable bottom, such that a pet is substantially prevented from accessing said freezable gel insert;
wherein said removable bottom has one or more non-skid portions;
wherein said one or more non-skid portions are positioned on an underside of said removable bottom;
wherein said one or more non-skid portions on said under side of said removable bottom substantially prevent said removable bottom from skidding;
wherein a bottom surface of said bowl has one or more non-skid portions, such that when said removable bottom is not attached to said bowl said one or more non-skid portions on said bottom surface of said bowl substantially prevent said bowl from skidding;
wherein when said freezable gel insert is contained within said bowl by said removable bottom, said bowl includes one or more insulating air pockets;
wherein one of said one or more insulating air pockets is located between an outer side of said freezable gel insert and an outer side of said bowl;
wherein said removable bottom includes one or more ring shaped raised portions;
wherein said one or more ring shaped raised portions are on an upper surface of said removable bottom;
wherein when said freezable gel insert is contained within said bowl by said removable bottom said one or more ring shaped raised portions create one of said one or more insulating air pockets between said freezable gel insert and an upper surface of said removable bottom;
wherein said removable bottom includes a raised lip;
wherein when said removable bottom is attached to said bowl said raised lip of said removable bottom is configured to capture a liquid that is spilled from a concave receptacle of said bowl;
wherein when said removable bottom is attached to said bowl said raised lip and a rim of said bowl combine to form a trough, such that when said trough is filled with liquid, said trough forms a barrier that substantially prevents pests from accessing said concave receptacle of said bowl;
wherein said freezable gel insert is a high density polyethylene container that contains a non-toxic freezable gel;
wherein said freezable gel insert includes one or more insulating air gaps on a surface of said high density polyethylene container;
wherein said one or more insulating air gaps on said freezable gel insert are configured to accommodate an expansion of said non-toxic freezable gel such that said high density polyethylene container is substantially prevented from deforming as a result of repeated use;
wherein said bowl and said removable bottom are substantially stainless steel.
